(19) United States
(12) Patent Application Publication
(10) Pub. No.: US 2026/0040049 A1
(43) Pub. Date: Feb. 5, 2026

(54) METHOD AND APPARATUS OF CELL SELECTION AND CELL RESELECTION FOR SUPPORTING EMERGENCY SERVICES IN WIRELESS NETWORK

(71) Applicant: Samsung Electronics Co., Ltd., Suwon-si, Gyeonggi-do (KR)

(72) Inventors: Vinay Kumar SHRIVASTAVA, Bangalore (IN); Sangyeob JUNG, Suwon-si (KR); Aditya Kumar PADHI, Bangalore (IN); Isakkiraja ISAKKI, Bangalore (IN)

(21) Appl. No.: 19/101,470

(22) PCT Filed: Aug. 11, 2023
(86) PCT No.: PCT/KR2023/011924

§ 371 Date: Feb. 5, 2025

(30) Foreign Application Priority Data
Aug. 11, 2022 (IN) 202241045879
Jul. 10, 2023 (IN) 2022 41045879

(51) Int. Cl. H04W 4/90; H04W 48/02; H04W 48/20; H04W 76/50

(52) U.S. Cl. CPC H04W 4/90; H04W 48/02; H04W 48/20; H04W 76/50

(57) ABSTRACT

The disclosure relates to a 5G or 6G communication system for supporting a higher data transmission rate. The present disclosure provides methods for supporting emergency service in wireless network (1000) by UE (100). In an embodiment, when a current cell on which the UE (100) is camped. does not support the emergency service. the method includes executing for the current cell or a frequency of the current cell at least one of: barring the current cell or the frequency of the current cell and starting one of a cell barring timer for the barred current cell or a frequency barring timer for the barred frequency of the current cell. Further, the method includes deprioritizing the current cell or the frequency of the current cell with a lowest priority for performing cell selection or cell reselection. Further, the method includes allowing the UE to perform the cell selection or cell reselection on cells other than the current cell or the frequency of the current cell.

### TECHNICAL FIELD

The present invention relates to a wireless network, and more specifically related to a method for performing cell selection and cell reselection for supporting emergency services for a User Equipment (UE) in a wireless network.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication technologies like 4th Generation (4G) and 5th Generation (5G) do not support Circuit Switched (CS) calls. They rely on an IP Multimedia Sub-system (IMS) to provide such services including emergency services via Packet Switched (PS) calls. A UE knows whether a concerned cell supports the emergency services or not upon reception of system information block index one, more commonly referred to as SIB1. In any cell state, if the UE supports voice services, and the current cell does not support an IMS emergency calls as indicated in the SIB1, the UE shall perform the cell selection and/or reselection to an acceptable cell which supports emergency call in any supported Radio Access Technology (RAT). If the UE is not in a Stand-alone Non-Public Network (SNPN) mode, the support for emergency service is indicated by ims-EmergencySupport. In the SNPN mode, the support for the emergency service is indicated by ims-EmergencySupportForSNPN. In an eCall only mode, the support for emergency call is indicated in eCallOverIms-Support.

In Any Cell (limited service) State, intra-frequency, inter-frequency and inter-RAT reselections are allowed. The UE continuously monitors the neighboring cells in same and/or different RATs and once the Radio Signal Strength Indicator (RSSI) criteria for reselection is satisfied (or may comprise any relevant signal strength and/or quality threshold criteria configured and/or specified for cell reselection), reselection to the target cell is triggered. While trying to camp on the cell, the UE comes to know whether the cell supports the emergency services or not.

In the scenario where the UE is camped on an acceptable cell that supports the IMS emergency call, however, the candidate cell(s) is not supporting the emergency service but has better channel conditions than that of the acceptable cell which supports the emergency services, it is quite likely that reselection might be triggered to the cell which does not support the emergency services (as the reselection criteria is satisfied as per 3rd Generation Partnership Project (3GPP) specification). Further, the UE may reselects the acceptable cell that supports the IMS emergency call, in order to avail IMS emergency calls support (as per the 3GPP specification). A ping-pong of cell reselection would result in bad user experience and battery power drain issues as the SIB decoding for the neighbor cells will happen frequently leading to more Radio Frequency (RF) circuitry usage.

Therefore, there is a need of a method and system to overcome or at least alleviate the afore-mentioned drawbacks.

### DISCLOSURE OF INVENTION

### Technical Problem

The present invention has been made to address at least the above problems and/or disadvantages and to provide at least the advantages described below. Accordingly, an aspect of the present invention provides a method and an apparatus of cell selection and cell reselection for supporting emergency services in wireless network.

The principal object of the embodiments herein is to provide a method of performing cell selection and cell reselection for supporting emergency services for a UE in a wireless network.

Another object of the embodiments herein is to determine whether a current cell supports the emergency service or does not support the emergency service.

Another object of the embodiments herein is to execute the current cell or a frequency of the current cell at least one of: barring the current cell or the frequency of the current cell and starting one of a cell barring timer for the barred current cell or a frequency barring timer for the barred frequency of the current cell, deprioritizing the current cell or the frequency of the current cell with a lowest priority for performing cell selection or cell reselection, and allowing the UE to perform the cell selection or cell reselection on cells other than the current cell or the frequency of the current cell, when the current cell on which the UE is camped, does not support the emergency service.

Another object of the embodiments herein is to execute a previous cell on which the UE is camped or a frequency of the previous cell that does not support the emergency service at least one of barring the previous cell or the frequency of the previous cell and starting one of a cell barring timer for the barred previous cell or a frequency barring timer for the barred frequency of the previous cell, deprioritizing the previous cell or the frequency of the previous cell with a lowest priority for performing cell the selection or cell reselection, and allowing the UE to perform the cell selection or cell reselection on cells other than the previous cell or the frequency of the previous cell when the current cell on which the UE is camped, supports the emergency service.

### Solution to Problem

Accordingly, the embodiments herein provide a method for supporting an emergency service in a wireless network. The method includes detecting, by a UE, a current cell on which the UE is camped, where the UE is in an any cell state and the UE is in one of a SNPN access mode and a non-SNPN access mode. Further, the method includes determining, by the UE, whether the current cell supports the emergency service or does not support the emergency service. In an embodiment, when the current cell on which the UE is camped, does not support the emergency service, the method includes executing for the current cell or a frequency of the current cell at least one of: barring the current cell or the frequency of the current cell and starting one of a cell barring timer for the barred current cell or a frequency barring timer for the barred frequency of the current cell. Further, the method includes deprioritizing the current cell or the frequency of the current cell with a lowest priority for performing cell selection or cell reselection. Further, the method includes allowing the UE to perform the cell selection or cell reselection on cells other than the current cell or the frequency of the current cell. In another embodiment, when the current cell on which the UE is camped, supports the emergency service, the method includes executing for a previous cell on which the UE is camped or a frequency of the previous cell that does not support the emergency service at least one of: barring the previous cell or the frequency of the previous cell and starting one of a cell barring timer for the barred previous cell or a frequency barring timer for the barred frequency of the previous cell. Further, the method includes deprioritizing the previous cell or the frequency of the previous cell with a lowest priority for performing cell the selection or cell reselection. Further, the method includes allowing the UE to perform the cell selection or cell reselection on cells other than the previous cell or the frequency of the previous cell.

In an embodiment, when the current cell on which the UE is camped, does not support the emergency service, the method includes determining, by the UE, an availability of a suitable cell on all frequencies of all Radio Access Technologies (RATs) supported by the UE. In an embodiment, the method includes camping the UE to the suitable cell and moving to a camped normal state, when the suitable cell is available. In an embodiment, the method includes performing the cell selection or cell reselection to a cell that supports the emergency service in any supported RAT regardless of priorities provided in system information from the current cell, when the suitable cell is not available.

In an embodiment, when the current cell on which the UE is camped, does not support the emergency service, the method includes determining, by the UE, that the cell barring timer for the barred current cell or the frequency barring timer for the barred frequency of the current cell is expired. Further, the method includes allowing the UE to perform the cell selection or cell reselection on the cells including the current cell or the frequency of the current cell based on the determination.

In an embodiment, the barring of the current cell or the frequency is for a pre-configured or a pre-specified time duration. The UE maintains a cell barring timer or a frequency barring timer to track of a barring operation.

In an embodiment, when the frequency barring timer expires, the UE considers the frequency or the current cell pertaining to the frequency for at least one of cell selection and cell reselection.

In an embodiment, when the current cell on which the UE is camped, supports the emergency service, the method includes determining, by the UE, that the cell barring timer for the barred previous cell or the frequency barring timer for the barred frequency of the previous cell is expired. Further, the method includes allowing the UE to perform the cell selection or cell reselection on the cells including the previous cell or the frequency of the previous cell based on the determination.

In an embodiment, when the current cell on which the UE is camped, does not support the emergency service, the method includes starting, by the UE, a de-prioritization timer for the deprioritized current cell or a frequency de-prioritization timer for the deprioritized frequency of the current cell. Further, the method includes determining, by the UE, that the de-prioritization timer or the frequency de-prioritization timer is expired. Further, the method includes allowing the UE to perform the cell selection or cell reselection on the cells including the current cell or the frequency of the current cell based on the determination.

In an embodiment, when the current cell on which the UE is camped, supports the emergency service, the method includes starting, by the UE, a de-prioritization timer for the deprioritized previous cell or a frequency de-prioritization timer for the deprioritized frequency of the previous cell. Further, the method includes determining, by the UE, that the de-prioritization timer or the frequency de-prioritization timer is expired. Further, the method includes allowing the UE to perform the cell selection or cell reselection on the cells including the previous cell or the frequency of the previous cell based on the determination.

In an embodiment, the de-prioritization of the cell or the frequency is for a pre-configured or a pre-specified time duration, where the UE maintains a cell de-prioritization timer or a frequency de-prioritization timer to track of a de-prioritization operation.

In an embodiment, when the frequency de-prioritization timer expires, where the UE considers the frequency for at least one of cell selection and cell reselection.

In an embodiment, when the current cell on which the UE is camped, supports the emergency service, the method includes determining, by the UE, at least one candidate cell satisfying a cell reselection criteria. Further, the method includes executing, by the UE, for the at least one candidate cell or a frequency of the at least one candidate cell that does not support the emergency service at least one of: barring the at least one candidate cell or the frequency of the at least one candidate cell and starting one of a cell barring timer for the at least one barred candidate cell or a frequency barring timer for the barred frequency of the at least one candidate cell. Further, the method includes deprioritizing the at least one candidate cell or the frequency of the at least one candidate cell with a lowest priority for performing the cell selection or cell reselection. Further, the method includes allowing the UE to perform the cell selection or cell reselection on cells other than the at least one candidate cell or the frequency of the at least one candidate cell.

In an embodiment, the method includes determining, by the UE, an optimal cell that satisfies a cell reselection criteria and supports the emergency service. Further, the method includes reselecting, by the UE, the optimal cell as per a cell reselection procedure.

In an embodiment, the method includes determining, by the UE, that the cell barring timer or the frequency barring timer for the barred at least one candidate cell is expired. Further, the method includes allowing the UE to perform the cell selection or cell reselection on the cells including the at least one candidate cell or the frequency of the at least one candidate cell based on the determination.

In an embodiment, when the current cell on which the UE is camped, supports the emergency service, the method includes starting, by the UE, a de-prioritization timer for the deprioritized at least one candidate cell or a frequency de-prioritization timer for the deprioritized frequency of the at least one candidate cell. Further, the method includes determining, by the UE, that the de-prioritization timer or the frequency de-prioritization timer is expired. Further, the method includes allowing the UE to perform the cell selection or cell reselection on the cells including the at least one candidate cell or the frequency of the at least one candidate cell based on the determination.

Accordingly, the embodiments herein provide a UE for supporting emergency service in a wireless network. The UE includes an emergency service support controller communicatively coupled to the memory and the processor. The emergency service support controller is configured for detecting a current cell on which the UE is camped. The UE is in an any cell state and the UE is in one of a SNPN access mode and a non-SNPN access mode. Further, the emergency service support controller is configured for determining whether the current cell supports the emergency service or does not support the emergency service. In an embodiment, when the current cell on which the UE is camped, does not support the emergency service, the emergency service support controller is configured for executing for the current cell or a frequency of the current cell at least one of: barring the current cell or the frequency of the current cell and starting one of a cell barring timer for the barred current cell or a frequency barring timer for the barred frequency of the current cell, deprioritizing the current cell or the frequency of the current cell with a lowest priority for performing cell selection or cell reselection, and allowing the UE to perform the cell selection or cell reselection on cells other than the current cell or the frequency of the current cell. In an embodiment, when the current cell on which the UE is camped, supports the emergency service, the emergency service support controller is configured to execute a previous cell on which the UE is camped or a frequency of the previous cell that does not support the emergency service at least one of: barring the previous cell or the frequency of the previous cell and starting one of a cell barring timer for the barred previous cell or a frequency barring timer for the barred frequency of the previous cell, deprioritizing the previous cell or the frequency of the previous cell with a lowest priority for performing cell the selection or cell reselection, and allowing the UE to perform the cell selection or cell reselection on cells other than the previous cell or the frequency of the previous cell.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and an apparatus of cell selection and cell reselection for supporting emergency services in wireless network.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for supporting an emergency service, according to the embodiments of the present invention;

FIG. 2A shows various hardware components of a UE, according to the embodiments as disclosed herein;

FIG. 2B shows various hardware components of a network apparatus, according to the embodiments as disclosed herein;

FIG. 3 is a flow chart illustrating a method for supporting the emergency service in the wireless network, according to the embodiments of the present invention;

FIG. 4 is a flow chart illustrating a method of performing cell selection and reselection for supporting the emergency services for the in the wireless network when the UE is camped on an acceptable cell which does not support IMS emergency calls, according to the embodiments of the present invention; and

FIG. 5 is a flow chart illustrating a method of performing the cell selection and the reselection for supporting the emergency services for the UE in the wireless network when the UE is camped on an acceptable cell which supports the IMS emergency calls, according to the embodiments of the present invention.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a method for supporting an emergency service in a wireless network. The method includes detecting, by a UE, a current cell on which the UE is camped. The UE is in an any cell state and the UE is in one of a SNPN access mode and a non-SNPN access mode. Further, the method includes determining, by the UE, whether the current cell supports the emergency service or does not support the emergency service. In an embodiment, when the current cell on which the UE is camped, does not support the emergency service, the method includes executing for the current cell or a frequency of the current cell at least one of: barring the current cell or the frequency of the current cell and starting one of a cell barring timer for the barred current cell or a frequency barring timer for the barred frequency of the current cell, deprioritizing the current cell or the frequency of the current cell with a lowest priority for performing cell selection or cell reselection, and allowing the UE to perform the cell selection or cell reselection on cells other than the current cell or the frequency of the current cell. In another embodiment, when the current cell on which the UE is camped, supports the emergency service, the method includes executing for a previous cell on which the UE is camped or a frequency of the previous cell that does not support the emergency service at least one of: barring the previous cell or the frequency of the previous cell and starting one of a cell barring timer for the barred previous cell or a frequency barring timer for the barred frequency of the previous cell, deprioritizing the previous cell or the frequency of the previous cell with a lowest priority for performing cell the selection or cell reselection, and the method includes allowing the UE to perform the cell selection or cell reselection on cells other than the previous cell or the frequency of the previous cell.

The proposed method can be used to enhance the better user experience and saves the battery power usage at the UE.

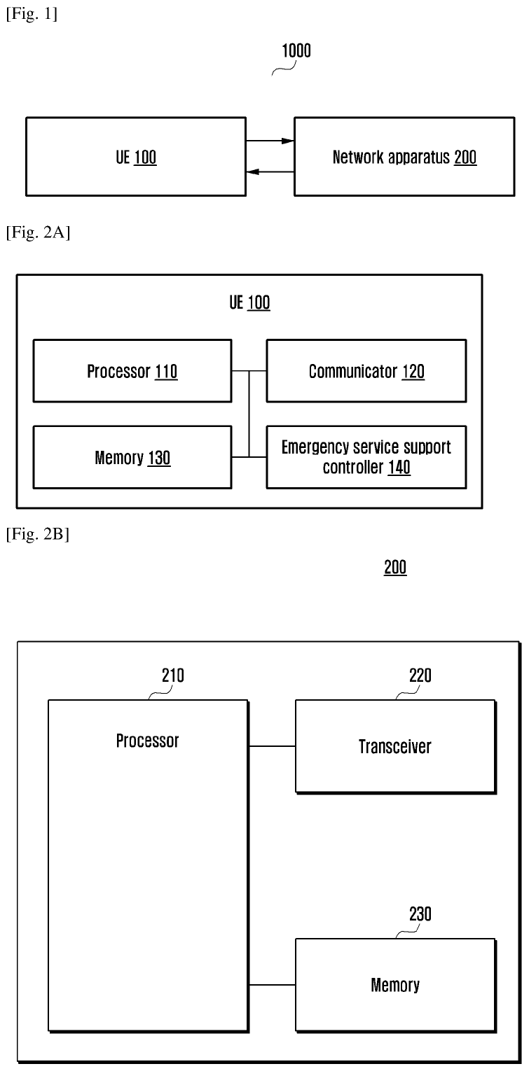

Referring now to the drawings, and more particularly to FIGS. 1 through 5, there are shown preferred embodiments.

FIG. 1 illustrates a wireless network (1000) for supporting emergency service, according to the embodiments of the present invention. The wireless network (1000) can be, for example, but not limited to a fourth generation (4G) network, a fifth generation (5G) network, an Open Radio Access Network (ORAN), and a sixth generation (6G) network. In an embodiment, the emergency service can be at least one of an IMS emergency call, an eCallOverIMS, an emergency call, a public safety service, an Earthquake and Tsunami Warning Service (ETWS) service, a Public Warning System (PWS) service, and a Mission Critical Push-To-Talk (MC-PTT) service. For remainder of the invention description, the IMS emergency call is referred in the patent discourse, however, it does not limit the scope and the applicability of the invention in any manner.

In an embodiment, the wireless network (1000) includes a UE (100) and a network apparatus (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a ENB, a new radio (NR) trans-receiver or the like.

The UE (100) detects a current cell on which the UE (100) is camped. The UE (100) is in an any cell state and the UE (100) is in one of a SNPN access mode and a non-SNPN access mode. Further, the UE (100) determines whether the current cell supports an emergency service or does not support the emergency service.

When the current cell on which the UE (100) is camped, does not support the emergency service, the UE (100) executes the current cell or a frequency of the current cell at least one of: barring the current cell or the frequency of the current cell and starting one of a cell barring timer for the barred current cell or a frequency barring timer for the barred frequency of the current cell, deprioritizes the current cell or the frequency of the current cell with a lowest priority for performing cell selection or cell reselection, and allowing the UE (100) to perform the cell selection or cell reselection on cells other than the current cell or the frequency of the current cell.

When the current cell on which the UE (100) is camped, supports the emergency service, the UE (100) executes a previous cell on which the UE (100) is camped or a frequency of the previous cell that does not support the emergency service at least one of: barring the previous cell or the frequency of the previous cell and starting one of a cell barring timer for the barred previous cell or a frequency barring timer for the barred frequency of the previous cell, deprioritizing the previous cell or the frequency of the previous cell with a lowest priority for performing cell the selection or cell reselection, and allowing the UE (100) to perform the cell selection or cell reselection on cells other than the previous cell or the frequency of the previous cell.

In legacy, if the UE (100) supports voice services and the “current cell” does not support the IMS emergency calls as the current cell does not support the IMS emergency calls as indicated by a field ims-EmergencySupport in SIB1, the UE (100) performs the cell selection/reselection to an acceptable cell that supports emergency calls in any supported RAT regardless of priorities provided in system information from current cell, if no suitable cell is found.

In an embodiment, when the UE (100) is camped in any cell state on the “current cell” (i.e. the cell that does not support IMS emergency calls) the UE (100) does not take the frequency of the “current cell” into account for performing one of cell selection or cell reselection. The UE (100) can be in one of the SNPN access mode or the non-SNPN access mode (i.e., not in SNPN access mode).

In an embodiment, when the UE (100) is camped in Any cell state on the “current cell” (i.e. the cell that does not support the IMS emergency calls) the UE (100) does not take the “current cell” into account for performing one of cell selection or cell reselection. The UE (100) can be in one of the SNPN access mode or not in the SNPN access mode.

In an embodiment, when the UE (100) is camped on one of an acceptable cell of a Public Land Mobile Network (PLMN) or on an acceptable cell of the SNPN that supports the IMS emergency calls the UE (100) does not take the frequency of the previously camped cell that does not support the IMS emergency calls into account for performing one of cell selection or cell reselection. The UE (100) can be in one of the SNPN access mode or not in the SNPN access mode.

In an embodiment, when the UE (100) is camped on one of an acceptable cell of the PLMN or on an acceptable cell of the SNPN that supports the IMS emergency calls the UE (100) does not take the frequency of the cell, that does not support IMS emergency calls, into account for performing one of cell selection or cell reselection. The UE (100) can be in one of SNPN access mode or not in SNPN access mode.

In an embodiment, when the UE (100) is camped on one of an acceptable cell of the PLMN or on an acceptable cell of the SNPN that supports IMS emergency calls the UE (100) does not take the previously camped cell that does not support IMS emergency calls, into account for performing one of cell selection or cell reselection. The UE (100) can be in one of the SNPN access mode or not in the SNPN access mode.

In an embodiment, when the UE (100) is camped on one of an acceptable cell of the PLMN or on the acceptable cell of the SNPN that supports the IMS emergency calls, the UE (100) does not take the cell that does not support the IMS emergency calls, into account for performing one of cell selection or cell reselection. The UE (100) can be in one of the SNPN access mode or not in the SNPN access mode.

In an embodiment, when the UE (100) is camped on one of an acceptable cell of the PLMN or on an acceptable cell of the SNPN that supports IMS emergency calls the UE (100) considers the candidate cell(s) that does not support IMS emergency calls as barred for performing one of cell selection or cell reselection. The UE (100) can be in one of the SNPN access mode or not in the SNPN access mode. The barring of the cell can be for a pre-configured or a pre-specified time duration T seconds (e.g. 300 seconds). The UE (100) may maintain a cell barring timer Txxx to track of the barring operation. When the cell barring timer Txxx expires, the UE (100) considers the cell(s) as debarred and considers cell(s) for cell selection and/or cell reselection.

In an embodiment, when the UE (100) is camped on one of an acceptable cell of the PLMN or on an acceptable cell of the SNPN that supports IMS emergency calls the UE (100) considers the previously camped cell(s) that does not support IMS emergency calls as barred for performing one of cell selection or cell reselection. The UE (100) can be in one of the SNPN access mode or not in the SNPN access mode. The barring of the cell can be for a pre-configured or a pre-specified time duration T seconds (e.g. 300 seconds). The UE (100) may maintain a cell barring timer Txxx to track of the barring operation. When the cell barring timer Txxx expires, the UE (100) considers the cell(s) as debarred and considers cell(s) for cell selection and/or cell reselection.
Example:
   1. In Any Cell state, if the cell is to be treated as if the cell status is “barred” due to not supporting the IMS emergency calls:
      a. The UE (100) may exclude the barred cell as a candidate for cell selection/reselection for up to 300 seconds.

Further, in an embodiment, the UE (100) may exclude the barred cell (i.e. the cell that is to be treated as if the cell status is “barred” due to not supporting the IMS emergency calls) as a candidate for cell selection/reselection for T seconds (e.g. 300 seconds). However, the UE (100) may select another cell on the same frequency as that of the barred cell if a cell selection/re-selection criteria are fulfilled. The UE (100) can be in one of the SNPN access mode or not in the SNPN access mode.
Example:
   1. In Any Cell state, if the cell is to be treated as if the cell status is “barred” due to not supporting the IMS emergency calls:
      a. The UE (100) may exclude the barred cell as the candidate for the cell selection/reselection for up to 300 seconds.
      b. The UE (100) may select/reselect another cell on the same frequency if the selection/reselection criteria are fulfilled.

Further, in an embodiment, the UE (100) does not select/re-select to another cell on the same frequency as that of the barred cell (i.e. the cell that is to be treated as if the cell status is “barred” due to not supporting IMS emergency calls) and excludes such cell(s) as candidate(s) for cell selection/reselection for T seconds (e.g. 300 seconds). The UE (100) can be in one of the SNPN access mode or not in the SNPN access mode.
Example:
   1. In Any Cell state, if the cell is to be treated as if the cell status is “barred” due to not supporting the IMS emergency calls:
      a. The UE (100) may exclude the barred cell as a candidate for cell selection/reselection for up to 300 seconds.
      b. The UE (100) shall not select/re-select to another cell on the same frequency as the barred cell and exclude such cell(s) as candidate(s) for cell selection/reselection for 300 seconds.

In an embodiment, when the UE (100) is camped in on the acceptable cell of the PLMN or on the acceptable cell of the SNPN that supports IMS emergency calls the UE (100) considers the frequency of the previously camped cell(s) that does not support IMS emergency calls as barred for performing one of cell selection or cell reselection. The UE (100) can be in one of the SNPN access mode or not in the SNPN access mode. The barring of the frequency can be for the pre-configured or the pre-specified time duration T seconds (e.g. 300 seconds). The UE (100) may maintain a frequency barring timer Tyyy to track of the barring operation. When the frequency barring timer Tyyy expires, the UE (100) considers the frequency as debarred and considers frequency or cell(s) pertaining to the frequency for cell selection and/or cell reselection.

In an embodiment, when the UE (100) is camped in on the acceptable cell of the PLMN or on the acceptable cell of the SNPN that supports IMS emergency calls the UE (100) considers the frequency of the candidate cell(s) that does not support the IMS emergency calls as barred for performing one of the cell selection or the cell reselection. The UE (100) can be in one of the SNPN access mode or not in the SNPN access mode. The barring of the frequency can be for the pre-configured or the pre-specified time duration T seconds (e.g. 300 seconds). The UE (100) may maintain the frequency barring timer Tyyy to track of the barring operation. When the frequency barring timer Tyyy expires, the UE (100) considers the frequency as debarred and considers frequency or cell(s) pertaining to the frequency for cell selection and/or cell reselection.

In an embodiment, when the UE (100) is camped in on the acceptable cell of the PLMN or on the acceptable cell of the SNPN that supports IMS emergency calls, the UE (100) deprioritize the frequency of the previously camped cell(s) that does not support IMS emergency calls as the lowest priority frequency for performing one of the cell selection or the cell reselection. The UE (100) can be in one of the SNPN access mode or not in the SNPN access mode. The de-prioritization of the frequency can be for a pre-configured or the pre-specified time duration T seconds (e.g. 300 seconds). The UE (100) may maintain a frequency de-prioritization timer Tzzz to track of the de-prioritization operation. When the frequency de-prioritization timer Tzzz expires, the UE (100) considers the frequency for cell selection and/or cell reselection.

In an embodiment, when the UE (100) is camped in on the acceptable cell of the PLMN or on the acceptable cell of the SNPN that supports IMS emergency calls, the UE (100) deprioritize the frequency of the candidate cell(s) that does not support IMS emergency calls as the lowest priority frequency for performing one of cell selection or cell reselection. The UE (100) can be in one of the SNPN access mode or not in the SNPN access mode. The de-prioritization of the frequency can be for a pre-configured or a pre-specified time duration T seconds (e.g. 300 seconds). The UE (100) may maintain a frequency de-prioritization timer Tzzz to track of the de-prioritization operation. When the frequency de-prioritization timer Tzzz expires, the UE (100) considers the frequency for cell selection and/or cell reselection.

In an embodiment, when the UE (100) is camped in on the acceptable cell of the PLMN or on the acceptable cell of the SNPN that supports IMS emergency calls the UE (100) deprioritize the “previously camped cell(s)” that does not support IMS emergency calls as the lowest priority cell(s) for performing one of cell selection or cell reselection. The UE (100) can be in one of the SNPN access mode or not in the SNPN access mode. The de-prioritization of the cell can be for a pre-configured or a pre-specified time duration T seconds (e.g. 300 seconds). The UE (100) may maintain a cell de-prioritization timer Tccc to track of the de-prioritization operation. When the cell de-prioritization timer Tccc expires, the UE (100) considers the cell for cell selection and/or cell reselection.

In an embodiment, when the UE (100) is camped in on the acceptable cell of the PLMN or on the acceptable cell of the SNPN that supports IMS emergency calls the UE (100) deprioritize the candidate cell(s) that does not support IMS emergency calls as the lowest priority cell(s) for performing one of cell selection or cell reselection. The UE (100) can be in one of the SNPN access mode or not in the SNPN access mode. The de-prioritization of the cell can be for the pre-configured or the pre-specified time duration T seconds (e.g. 300 seconds). The UE (100) may maintain the cell de-prioritization timer Tccc to track of the de-prioritization operation. When the cell de-prioritization timer Tccc expires, the UE (100) considers the cell for cell selection and/or cell reselection.

In an embodiment, when the UE (100) is camped in on an acceptable cell of the PLMN or on the acceptable cell of the SNPN that supports the IMS emergency calls, the UE (100) may not perform the cell selection or the cell reselection till the IMS emergency call is ongoing.

In an embodiment, when the UE (100) is camped in on the acceptable cell of the PLMN or on the acceptable cell of the SNPN that supports IMS emergency calls, the UE (100) may not perform cell selection or cell reselection till the signal strength or quality is not degraded more than a pre-configured or pre-specified or pre-determined threshold. That is the threshold can be at least one of configured by the network apparatus (300) or specified in the specification or determined by the UE implementation.

In an embodiment, when the UE (100) is in any cell state and camped on the acceptable cell, the UE (100) attempts to find the suitable cell. If the suitable cell is found, the UE (100) camps on suitable cell and moves to camped normally state.

In an embodiment, when the UE (100) is in the any cell state and performs cell reselection evaluation process. If there is no acceptable cell found, the UE (100) may move to the any cell selection state. Further, the UE (100) removes the cell or frequency barring and/or removes cell or frequency de-prioritization and/or removes any restriction and/or stops or resets cell/frequency barring timer and/or de-prioritization timer. In an embodiment, when the UE (100) is camped in on the acceptable cell of the PLMN or on the acceptable cell of the SNPN that supports IMS emergency calls the UE (100) de-prioritize the candidate cell(s) that does not support IMS emergency calls as the lowest priority cell(s) for performing one of cell selection or cell reselection. The UE (100) can be in one of the SNPN access mode or not in the SNPN access mode. The de-prioritization of the cell can be for a pre-configured or a pre-specified time duration T seconds (e.g. 300 seconds). The UE (100) may maintain a cell de-prioritization timer Tccc to track of the de-prioritization operation. When the cell de-prioritization timer Tccc expires, the UE (100) considers the cell for cell selection and/or cell reselection.

In an embodiment, when the UE (100) is camped in on the acceptable cell of the PLMN or on the acceptable cell of the SNPN that supports IMS emergency calls, the UE (100) may not perform cell selection or cell reselection till the IMS emergency call is ongoing.

In an embodiment, when the UE (100) is camped in on the acceptable cell of the PLMN or on the acceptable cell of the SNPN that supports IMS emergency calls, the UE (100) may not perform the cell selection or the cell reselection till the signal strength or quality is not degraded more than a pre-configured or pre-specified or pre-determined threshold. That is the threshold can be at least one of configured by the network apparatus (200) or specified in the specification or determined by the UE implementation.

In an embodiment, when the UE (100) is in any cell state and camped on the acceptable cell, the UE (100) attempts to find the suitable cell. If the suitable cell is found, the UE (100) camps on suitable cell and moves to camped normally state.

In an embodiment, when the UE (100) is in any cell state and performs cell reselection evaluation process. If there is no acceptable cell found, the UE (100) may move to the any cell selection state. Further, the UE (100) removes cell or frequency barring and/or removes cell or frequency de-prioritization and/or removes any restriction and/or stops or resets cell/frequency barring timer and/or de-prioritization timer.

In an embodiment, the “previously camped cell” that is addressed in the embodiments of the invention, may be at least one of the acceptable cell or the suitable cell or the barred cell or the reserved cell. In another embodiment, the “previously camped cell” that is addressed in the embodiments of the invention, may be from the cell information stored for the PLMN or the SNPN.

In an embodiment, the “candidate cell” that is addressed in the embodiments of the invention, may be at least one of the acceptable cell or the suitable cell or the barred cell or the reserved cell.

In an embodiment, the cell selection and/or the cell reselection as described in the embodiments of the invention pertains to at least one of the intra-frequency or the inter-frequency or the inter-RAT selection/reselection.

FIG. 2A shows various hardware components of the UE (100), according to the embodiments as disclosed herein. In an embodiment, the UE (100) includes a processor (110), a communicator (120), a memory (130) and an emergency service support controller (140). The processor (110) is coupled with the communicator (120), the memory (130) and the emergency service support controller (140).

The emergency service support controller (140) detects that the UE (100) is in an any cell state and the current cell on which the UE (100) is camped. The UE (100) is in one of the SNPN access mode and the non-SNPN access mode. Further, the emergency service support controller (140) determines whether the current cell supports the emergency service or does not support the emergency service.

When the current cell on which the UE (100) is camped, does not support the emergency service, the emergency service support controller (140) executes the current cell or the frequency of the current cell at least one of: barring the current cell or the frequency of the current cell and starting one of a cell barring timer for the barred current cell or a frequency barring timer for the barred frequency of the current cell, deprioritizing the current cell or the frequency of the current cell with a lowest priority for performing cell selection or cell reselection, and allowing the UE (100) to perform the cell selection or cell reselection on cells other than the current cell or the frequency of the current cell.

When the current cell on which the UE (100) is camped, supports the emergency service, the emergency service support controller (140) executes the previous cell on which the UE (100) is camped or a frequency of the previous cell that does not support the emergency service at least one of: barring the previous cell or the frequency of the previous cell and starting one of a cell barring timer for the barred previous cell or a frequency barring timer for the barred frequency of the previous cell, deprioritizing the previous cell or the frequency of the previous cell with a lowest priority for performing cell the selection or cell reselection, and allowing the UE (100) to perform the cell selection or cell reselection on cells other than the previous cell or the frequency of the previous cell.

Further, when the current cell on which the UE (100) is camped, does not support the emergency service, the emergency service support controller (140) determines an availability of a suitable cell on all frequencies of all RATs supported by the UE (100). Further, the emergency service support controller (140) camps the UE (100) to the suitable cell and moves to the camped normal state, when the suitable cell is available. Alternatively, the emergency service support controller (140) performs the cell selection or the cell reselection to the cell that supports the emergency service in any supported RAT regardless of priorities provided in system information from the current cell, when the suitable cell is not available.

Further, when the current cell on which the UE (100) is camped, does not support the emergency service, the emergency service support controller (140) determines that the cell barring timer for the barred current cell or the frequency barring timer for the barred frequency of the current cell is expired. Based on the determination, the emergency service support controller (140) allows the UE (100) to perform the cell selection or cell reselection on the cells including the current cell or the frequency of the current cell. The barring of the current cell or the frequency is for a pre-configured or a pre-specified time duration, wherein the UE (100) maintains a cell barring timer or a frequency barring timer to track of a barring operation. When the frequency barring timer expires, the UE (100) considers the frequency or the current cell pertaining to the frequency for at least one of cell selection and cell reselection.

In an embodiment, when the current cell on which the UE (100) is camped, supports the emergency service, the emergency service support controller (140) determines that the cell barring timer for the barred previous cell or the frequency barring timer for the barred frequency of the previous cell is expired. Based on the determination, the emergency service support controller (140) allows the UE (100) to perform the cell selection or cell reselection on the cells including the previous cell or the frequency of the previous cell.

In an embodiment, when the current cell on which the UE (100) is camped, does not support the emergency service, the emergency service support controller (140) stars the de-prioritization timer for the deprioritized current cell or the frequency de-prioritization timer for the deprioritized frequency of the current cell. Further, the emergency service support controller (140) determines that the de-prioritization timer or the frequency de-prioritization timer is expired. Based on the determination, the emergency service support controller (140) allows the UE (100) to perform the cell selection or cell reselection on the cells including the current cell or the frequency of the current cell.

In an embodiment, when the current cell on which the UE (100) is camped, supports the emergency service, the emergency service support controller (140) starts a de-prioritization timer for the deprioritized previous cell or the frequency de-prioritization timer for the deprioritized frequency of the previous cell. Further, the emergency service support controller (140) determines that the de-prioritization timer or the frequency de-prioritization timer is expired. Based on the determination, the emergency service support controller (140) allows the UE (100) to perform the cell selection or cell reselection on the cells including the previous cell or the frequency of the previous cell.

The de-prioritization of the cell or the frequency is for the pre-configured or the pre-specified time duration. The UE (100) maintains the cell de-prioritization timer or a frequency de-prioritization timer to track of a de-prioritization operation. When the frequency de-prioritization timer expires, the UE (100) considers the frequency for at least one of cell selection and cell reselection.

In an embodiment, when the current cell on which the UE (100) is camped, supports the emergency service, the emergency service support controller (140) determines at least one candidate cell satisfying the cell reselection criteria. Further, the emergency service support controller (140) executes the at least one candidate cell or the frequency of the at least one candidate cell that does not support the emergency service at least one of: barring the at least one candidate cell or the frequency of the at least one candidate cell and starting one of a cell barring timer for the at least one barred candidate cell or a frequency barring timer for the barred frequency of the at least one candidate cell, deprioritizing the at least one candidate cell or the frequency of the at least one candidate cell with a lowest priority for performing the cell selection or cell reselection, and allowing the UE (100) to perform the cell selection or cell reselection on cells other than the at least one candidate cell or the frequency of the at least one candidate cell.

In an embodiment, the emergency service support controller (140) determine an optimal cell that satisfies a reselection criteria and supports the emergency service. Further, the emergency service support controller (140) reselects the optimal cell as per a cell reselection procedure.

In an embodiment, the emergency service support controller (140) determines that the cell barring timer or the frequency barring timer for the barred at least one candidate cell is expired. Further, the emergency service support controller (140) allows the UE (100) to perform the cell selection or cell reselection on the cells including the at least one candidate cell or the frequency of the at least one candidate cell.

In an embodiment, when the current cell on which the UE (100) is camped, supports the emergency service, the emergency service support controller (140) starts a de-prioritization timer for the deprioritized at least one candidate cell or a frequency de-prioritization timer for the deprioritized frequency of the at least one candidate cell. Further, the emergency service support controller (140) determines that the de-prioritization timer or the frequency de-prioritization timer is expired. Based on the determination, the emergency service support controller (140) allows the UE (100) to perform the cell selection or cell reselection on the cells including the at least one candidate cell or the frequency of the at least one candidate cell.

The emergency service support controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2A shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 2B illustrates a network apparatus according to embodiments of the present disclosure.

Referring to the FIG. 2B, the network apparatus 200 may include a processor 210, a transceiver 220 and a memory 230. However, all of the illustrated components are not essential. The network apparatus 200 may be implemented by more or less components than those illustrated in FIG. 2B. In addition, the processor 210 and the transceiver 220 and the memory 230 may be implemented as a single chip according to another embodiment.

The network apparatus 200 may correspond to the gNB described above. For example, the network apparatus 200 may correspond to network apparatus 200 illustrated in FIG. 1.

The aforementioned components will now be described in detail.

The processor 210 may include one or more processors or other processing devices that control the proposed function, process, and/or method. Operation of the network apparatus 200 may be implemented by the processor 210.

The transceiver 220 may include a RF transmitter for up-converting and amplifying a transmitted signal, and a RF receiver for down-converting a frequency of a received signal. However, according to another embodiment, the transceiver 220 may be implemented by more or less components than those illustrated in components.

The transceiver 220 may be connected to the processor 210 and transmit and/or receive a signal. The signal may include control information and data. In addition, the transceiver 220 may receive the signal through a wireless channel and output the signal to the processor 210. The transceiver 220 may transmit a signal output from the processor 210 through the wireless channel.

The memory 230 may store the control information or the data included in a signal obtained by the network apparatus 200. The memory 230 may be connected to the processor 210 and store at least one instruction or a protocol or a parameter for the proposed function, process, and/or method. The memory 230 may include read-only memory (ROM) and/or random access memory (RAM) and/or hard disk and/or CDROM and/or DVD and/or other storage devices.

Although this disclosure has been described with an exemplary embodiment, various changes and modifications may be suggested to one skilled in the art. It is intended that this disclosure encompass such changes and modifications as fall within the scope of the appended claims.

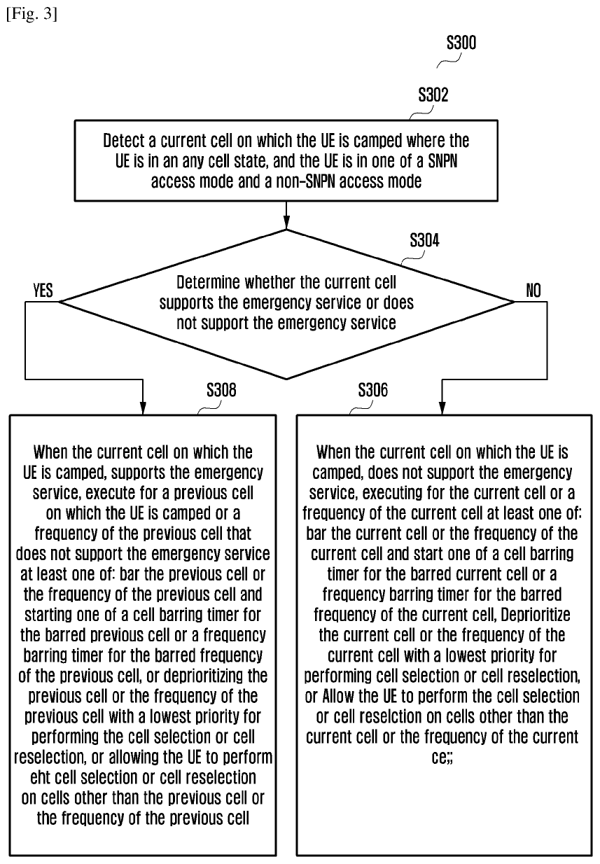

FIG. 3 is a flow chart (S300) illustrating a method for supporting the emergency service in the wireless network (1000), according to the embodiments of the present invention. The operations (S302-S308) are handled by the emergency service support controller (140).

At S302, the method includes detecting the current cell on which the UE (100) is camped. The UE (100) is in an any cell state and the UE (100) is in one of the SNPN access mode and the non-SNPN access mode. At S304, the method includes determining whether the current cell supports the emergency service or does not support the emergency service.

When the current cell on which the UE (100) is camped, does not support the emergency service, At S306, the method includes executing for the current cell or the frequency of the current cell at least one of: barring the current cell or the frequency of the current cell and starting one of the cell barring timer for the barred current cell or the frequency barring timer for the barred frequency of the current cell, deprioritizing the current cell or the frequency of the current cell with the lowest priority for performing cell selection or cell reselection, and allowing the UE (100) to perform the cell selection or cell reselection on cells other than the current cell or the frequency of the current cell.

When the current cell on which the UE (100) is camped, supports the emergency service, At S308, the method includes executing for the previous cell on which the UE (100) is camped or the frequency of the previous cell that does not support the emergency service at least one of: bar the previous cell or the frequency of the previous cell and starting one of a cell barring timer for the barred previous cell or the frequency barring timer for the barred frequency of the previous cell, deprioritizing the previous cell or the frequency of the previous cell with the lowest priority for performing the cell selection or cell reselection, and allowing the UE (100) to perform the cell selection or cell reselection on cells other than the previous cell or the frequency of the previous cell.

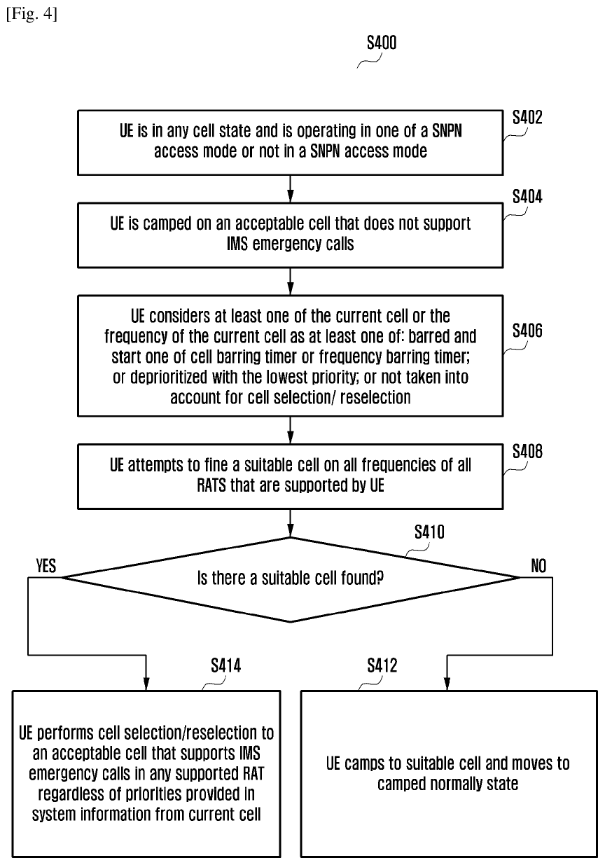

FIG. 4 is a flow chart (S400) illustrating a method for performing cell selection and reselection for supporting the emergency services for the UE (100) in the wireless network (1000) when the UE (100) is camped on the acceptable cell which does not support the IMS emergency calls, according to embodiments as disclosed herein.

At S402, the UE (100) is in any cell state and is operating in one of the SNPN access mode or not in the SNPN access mode. At S404, the UE (100) is camped on the acceptable cell that does not support the IMS emergency calls. At S406, the UE considers at least one of the current cell or the frequency of the current cell as at least one of: barred and start one of cell barring timer or frequency barring timer, or deprioritized with the lowest priority, or not taken into account for cell selection/reselection.

At S408, the UE (100) attempts to find the suitable cell on all frequencies of all RATS that are supported by the UE (100). At S410, Is there a suitable cell found? Upon determining that the suitable cell is found then, At S412, the UE (100) camps to suitable cell and moves to camped the normally state. Upon determining that the suitable cell is not found then, At S414, the UE (100) performs the cell selection/reselection to the acceptable cell that supports IMS emergency calls in any supported RAT regardless of priorities provided in the system information from the current cell.

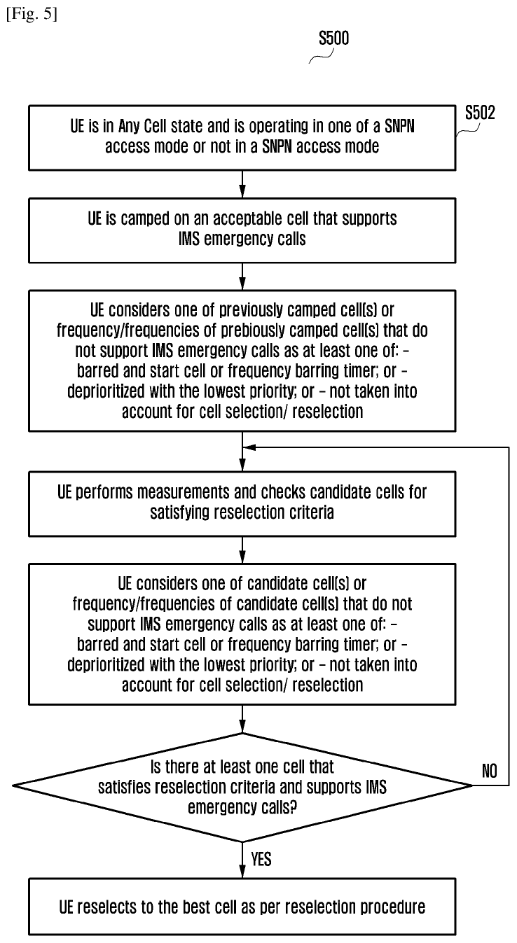

FIG. 5 is a flow chart (S500) illustrating a method of performing cell selection and reselection for supporting the emergency services for the UE (100) in the wireless network (1000) when the UE (100) is camped on an acceptable cell which supports IMS emergency calls, according to embodiments as disclosed herein.

At S502, the UE (100) is in any cell state and is operating in one of the SNPN access mode or not in the SNPN access mode. At S504, the UE (100) is camped on the acceptable cell that supports the IMS emergency calls. At S506, the UE (100) considers one of previously camped cell(s) or frequency/frequencies of previously camped cell(s) that do not support IMS emergency calls as at least one of: barred and start cell or frequency barring timer, or deprioritized with the lowest priority, or not taken into account for cell selection/reselection.

At S508, the UE (100) performs the measurements and determines the candidate cells for satisfying reselection criteria. At S510, the UE (100) considers one of candidate cell(s) or frequency/frequencies of candidate cell(s) that do not support IMS emergency calls as at least one of: barred and start cell or frequency barring timer, or deprioritized with the lowest priority, or not taken into account for cell selection/reselection. At S512, the method includes determining whether the at least one cell satisfies reselection criteria and supports the IMS emergency calls? Upon determining that the at least one cell satisfies reselection criteria and supports the IMS emergency calls then, at S514, the UE reselects to the best cell as per reselection procedure. Upon determining that the no cell satisfies the reselection criteria and supports the IMS emergency calls then, At S508, the UE (100) performs the measurements and determines the candidate cells for satisfying the reselection criteria.

The proposed method can be used to enhance the better user experience and saves the battery power usage at the UE.

The various actions, acts, blocks, steps, or the like in the flow charts (S300-S500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) for supporting an emergency service in a wireless network (1000), the method comprising:
detecting a current cell on which the UE (100) is camped, wherein the UE (100) is in an any cell state, and wherein the UE (100) is in one of a Stand-alone Non-Public Network (SNPN) access mode and a non-SNPN access mode;
determining whether the current cell supports the emergency service or does not support the emergency service; and
based on a result of the determination, performing a cell selection or a cell reselection on cells other than the current cell or cells other than a previous cell.

2. The method of claim 1, further comprises performing one of:
in case that the current cell on which the UE (100) is camped, does not support the emergency service, executing by the UE (100) for the current cell or a frequency of the current cell at least one of: barring the current cell or the frequency of the current cell and starting one of a cell barring timer for the barred current cell or a frequency barring timer for the barred frequency of the current cell, deprioritizing the current cell or the frequency of the current cell with a lowest priority for performing cell selection or cell reselection, and allowing the UE (100) to perform the cell selection or cell reselection on cells other than the current cell or the frequency of the current cell, and
in case that the current cell on which the UE (100) is camped, supports the emergency service, executing by the UE (100) for a previous cell on which the UE (100) is camped or a frequency of the previous cell that does not support the emergency service at least one of: barring the previous cell or the frequency of the previous cell and starting one of a cell barring timer for the barred previous cell or a frequency barring timer for the barred frequency of the previous cell, deprioritizing the previous cell or the frequency of the previous cell with a lowest priority for performing cell the selection or cell reselection, and allowing the UE (100) to perform the cell selection or cell reselection on cells other than the previous cell or the frequency of the previous cell.

3. The method of claim 1, wherein, in case that the current cell on which the UE (100) is camped, does not support the emergency service, the method comprises:
determining, by the UE (100), an availability of a suitable cell on all frequencies of all Radio Access Technologies (RATs) supported by the UE (100); and
performing, by the UE (100), one of:
camping the UE (100) to the suitable cell and moving to a camped normal state, in case that the suitable cell is available, and
performing the cell selection or cell reselection to a cell that supports the emergency service in any supported RAT regardless of priorities provided in system information from the current cell, in case that the suitable cell is not available.

4. The method of claim 1, wherein, in case that the current cell on which the UE (100) is camped, does not support the emergency service, the method comprises:
determining, by the UE (100), whether the cell barring timer for the barred current cell or the frequency barring timer for the barred frequency of the current cell is expired; and
allowing the UE (100) to perform the cell selection or cell reselection on the cells including the current cell or the frequency of the current cell,
wherein the barring of the current cell or the frequency is for a pre-configured or a pre-specified time duration,
wherein the UE (100) maintains a cell barring timer or a frequency barring timer to track of a barring operation, and
wherein in case that the frequency barring timer expires, the UE (100) considers the frequency or the current cell pertaining to the frequency for at least one of cell selection and cell reselection.

5. The method of claim 1, further comprises performing one of:
wherein, in case that the current cell on which the UE (100) is camped, supports the emergency service, the method comprises determining, by the UE (100), whether the cell barring timer for the barred previous cell or the frequency barring timer for the barred frequency of the previous cell is expired, and allowing the UE (100) to perform the cell selection or cell reselection on the cells including the previous cell or the frequency of the previous cell; and
wherein, in case that the current cell on which the UE (100) is camped, does not support the emergency service, the method comprises starting, by the UE (100), a de-prioritization timer for the deprioritized current cell or a frequency de-prioritization timer for the deprioritized frequency of the current cell, determining, by the UE (100), whether the de-prioritization timer or the frequency de-prioritization timer is expired, and allowing the UE (100) to perform the cell selection or cell reselection on the cells including the current cell or the frequency of the current cell.

6. The method of claim 1, wherein, in case that the current cell on which the UE (100) is camped, supports the emergency service, the method further comprises:
starting, by the UE (100), a de-prioritization timer for the deprioritized previous cell or a frequency de-prioritization timer for the deprioritized frequency of the previous cell;
determining, by the UE (100), whether the de-prioritization timer or the frequency de-prioritization timer is expired; and
allowing the UE (100) to perform the cell selection or cell reselection on the cells including the previous cell or the frequency of the previous cell,
wherein the de-prioritization of the cell or the frequency is for a pre-configured or a pre-specified time duration,
wherein the UE (100) maintains a cell de-prioritization timer or a frequency de-prioritization timer to track of a de-prioritization operation, and
wherein in case that the frequency de-prioritization timer expires, wherein the UE (100) considers the frequency for at least one of cell selection and cell reselection.

7. The method of claim 1, wherein, in case that the current cell on which the UE (100) is camped, supports the emergency service, the method comprises:
determining, by the UE (100), at least one candidate cell satisfying a cell reselection criteria; and
executing, by the UE (100), the at least one candidate cell or a frequency of the at least one candidate cell that does not support the emergency service at least one of: barring the at least one candidate cell or the frequency of the at least one candidate cell and starting one of a cell barring timer for the at least one barred candidate cell or a frequency barring timer for the barred frequency of the at least one candidate cell, deprioritizing the at least one candidate cell or the frequency of the at least one candidate cell with a lowest priority for performing the cell selection or cell reselection, and allowing the UE (100) to perform the cell selection or cell reselection on cells other than the at least one candidate cell or the frequency of the at least one candidate cell,
wherein the method further comprises performing one of:
determining, by the UE (100), an optimal cell that satisfies a reselection criteria and supports the emergency service, and reselecting, by the UE (100), the optimal cell as per a cell reselection procedure;
determining, by the UE (100), whether the cell barring timer or the frequency barring timer for the barred at least one candidate cell is expired, and allowing the UE (100) to perform the cell selection or cell reselection on the cells including the at least one candidate cell or the frequency of the at least one candidate cell; and
in case that the current cell on which the UE (100) is camped, supports the emergency service, the method comprises starting, by the UE (100), a de-prioritization timer for the deprioritized at least one candidate cell or a frequency de-prioritization timer for the deprioritized frequency of the at least one candidate cell, determining, by the UE (100), whether the de-prioritization timer or the frequency de-prioritization timer is expired, and allowing the UE (100) to perform the cell selection or cell reselection on the cells including the at least one candidate cell or the frequency of the at least one candidate cell.

8. A UE (100) for supporting emergency service in a wireless network (1000), wherein the UE (100) comprising:
a memory (130);
a processor (110); and
an emergency service support controller (140), communicatively coupled to the memory (130) and the processor (110), configured to:
detect that the UE (100) is in an any cell state and a current cell on which the UE (100) is camped, wherein the UE (100) is in one of a SNPN access mode and a non-SNPN access mode;
determine whether the current cell supports the emergency service or does not support the emergency service; and
based on a result of the determination, perform a cell selection or a cell reselection on cells other than the current cell or cells other than a previous cell.

9. The UE (100) of claim 8, wherein the emergency service support controller (140) further configured to perform one of:
in case that the current cell on which the UE (100) is camped, does not support the emergency service, execute the current cell or a frequency of the current cell at least one of: bar the current cell or the frequency of the current cell and start one of a cell barring timer for the barred current cell or a frequency barring timer for the barred frequency of the current cell, deprioritize the current cell or the frequency of the current cell with a lowest priority for performing cell selection or cell reselection, and allow the UE (100) to perform the cell selection or cell reselection on cells other than the current cell or the frequency of the current cell, and
in case that the current cell on which the UE (100) is camped, supports the emergency service, execute a previous cell on which the UE (100) is camped or a frequency of the previous cell that does not support the emergency service at least one of: bar the previous cell or the frequency of the previous cell and start one of a cell barring timer for the barred previous cell or a frequency barring timer for the barred frequency of the previous cell, deprioritize the previous cell or the frequency of the previous cell with a lowest priority for perform cell the selection or cell reselection, and allow the UE (100) to perform the cell selection or cell reselection on cells other than the previous cell or the frequency of the previous cell.

10. The UE (100) of claim 8, wherein, in case that the current cell on which the UE (100) is camped, does not support the emergency service, the emergency service support controller (140) is configured to:
determine an availability of a suitable cell on all frequencies of all Radio Access Technologies (RATs) supported by the UE (100), and perform one of:
camp the UE (100) to the suitable cell and moving to a camped normal state, in case that the suitable cell is available, and
perform the cell selection or cell reselection to a cell that supports the emergency service in any supported RAT regardless of priorities provided in system information from the current cell, in case that the suitable cell is not available.

11. The UE (100) of claim 8, wherein, in case that the current cell on which the UE (100) is camped, does not support the emergency service, the emergency service support controller (140) is configured to:
determine whether the cell barring timer for the barred current cell or the frequency barring timer for the barred frequency of the current cell is expired, and
allow the UE (100) to perform the cell selection or cell reselection on the cells including the current cell or the frequency of the current cell,
wherein the barring of the current cell or the frequency is for a pre-configured or a pre-specified time duration,
wherein the UE (100) maintains a cell barring timer or a frequency barring timer to track of a barring operation, and
wherein in case that the frequency barring timer expires, the UE (100) considers the frequency or the current cell pertaining to the frequency for at least one of cell selection and cell reselection.

12. The UE (100) of claim 8, the emergency service support controller (140) is configured to perform one of:
wherein, in case that the current cell on which the UE (100) is camped, supports the emergency service, determine whether the cell barring timer for the barred previous cell or the frequency barring timer for the barred frequency of the previous cell is expired, and allow the UE (100) to perform the cell selection or cell reselection on the cells including the previous cell or the frequency of the previous cell, and
wherein, in case that the current cell on which the UE (100) is camped, does not support the emergency service, start a de-prioritization timer for the deprioritized current cell or a frequency de-prioritization timer for the deprioritized frequency of the current cell, determine whether the de-prioritization timer or the frequency de-prioritization timer is expired, and allow the UE (100) to perform the cell selection or cell re-selection on the cells including the current cell or the frequency of the current cell.

13. The UE (100) of claim 8, wherein, in case that the current cell on which the UE (100) is camped, supports the emergency service, the emergency service support controller (140) is configured to:
start a de-prioritization timer for the deprioritized previous cell or a frequency de-prioritization timer for the deprioritized frequency of the previous cell,
determine whether the de-prioritization timer or the frequency de-prioritization timer is expired, and
allow the UE (100) to perform the cell selection or cell reselection on the cells including the previous cell or the frequency of the previous cell,
wherein the de-prioritization of the cell or the frequency is for a pre-configured or a pre-specified time duration,
wherein the UE (100) maintains a cell de-prioritization timer or a frequency de-prioritization timer to track of a de-prioritization operation, and
wherein the UE (100) considers the frequency for at least one of cell selection and cell reselection, in case that the frequency de-prioritization timer expires.

14. The UE (100) of claim 8, wherein, in case that the current cell on which the UE (100) is camped, supports the emergency service, the emergency service support controller (140) is configured for:
determine at least one candidate cell satisfying a cell reselection criteria; and
execute the at least one candidate cell or a frequency of the at least one candidate cell that does not support the emergency service at least one of: bar the at least one candidate cell or the frequency of the at least one candidate cell and start one of a cell barring timer for the at least one barred candidate cell or a frequency barring timer for the barred frequency of the at least one candidate cell, deprioritize the at least one candidate cell or the frequency of the at least one candidate cell with a lowest priority for performing the cell selection or cell reselection, and allow the UE (100) to perform the cell selection or cell reselection on cells other than the at least one candidate cell or the frequency of the at least one candidate cell.

15. The UE (100) of claim 14, wherein the emergency service support controller (140) is configured to perform one of:
determine an optimal cell that satisfies a reselection criteria and supports the emergency service, and reselect the optimal cell as per a cell reselection procedure,
determine whether the cell barring timer or the frequency barring timer for the barred at least one candidate cell is expired, and allow the UE (100) to perform the cell selection or cell reselection on the cells including the at least one candidate cell or the frequency of the at least one candidate cell, and
in case that the current cell on which the UE (100) is camped, supports the emergency service, start a de-prioritization timer for the deprioritized at least one candidate cell or a frequency de-prioritization timer for the deprioritized frequency of the at least one candidate cell, determine whether the de-prioritization timer or the frequency de-prioritization timer is expired. and allow the UE (100) to perform the cell selection or cell reselection on the cells including the at least one candidate cell or the frequency of the at least one candidate cell.
